(19) United States
(12) Patent Application Publication
(10) Pub. No.: US 2003/0113632 A1
(43) Pub. Date: Jun. 19, 2003

(54) Oxidized titanium as a cathodic current collector

(76) Inventors: W. Richard Brown, Clarence Center, NY (US); Christine A. Frysz, New Milford, CT (US); Sally Ann Smesko, North Tonawanda, NY (US); Esther S. Takeuchi, East Amherst, NY (US)

Correspondence Address: Michael F. Scalise, Hodgson Russ LLP, One M&T Plaza, Suite 2000, Buffalo, NY, 14203-2391, US

(21) Appl. No.: 09/918,139

(22) Filed: Jul. 30, 2001

(51) Int. Cl. H01M 4/66; H01M 4/70; H01M 4/48; H01M 4/50; H01M 4/52; H01M 4/54; H01M 4/58; C25D 11/34

(52) U.S. Cl. 429/245; 429/241; 429/219; 429/220; 429/224; 429/231.5; 429/223; 429/231.8; 429/221; 429/231.7; 429/218.1; 429/217

(57) ABSTRACT

A titanium substrate having a thickened outer oxidation layer provided thereon by a treatment process performed either in an air atmosphere at elevated temperatures or through electrolytic oxidation (anodization), is described. The thusly conditioned titanium substrate serving as a cathode current collector for an electrode incorporated into an electrochemical cell exhibits improved electrical performance in comparison to the prior art techniques, i.e., electrically conducted carbon coated titanium screen and use of highly corrosion resistant materials, upon subsequent elevated temperature exposure.

### BACKGROUND OF THE INVENTION

1. Field of the Invention

The present invention generally relates to the conversion of chemical energy to electrical energy, and more particularly, to the treatment of a conductive substrate intended for subsequent use as a cathodic current collector. According to the present invention, the naturally-occurring oxide surface layer on a metallic current collector is substantially thickened by heating in an oxidizing atmosphere or through electrolytic oxidation. The thusly conditioned conductive substrate improves the efficiency of a subsequently constructed cell, especially an alkali metal electrochemical cell discharged at an elevated temperature.

2. Prior Art

Titanium metal cathode current collectors generally exhibit the excellent corrosion resistance and other characteristics needed to function in the electrochemically challenging environments existing within lithium/carbon monofluoride (Li/CFₓ) cells. However, under certain storage and/or elevated temperature treatment or discharge conditions, use of titanium current collectors results in poor or degraded cell performance. For example, current collector and cell performance can be degraded by long term storage at ambient temperature, by short term exposure to medical autoclave temperatures, and by high temperature discharge in commercial environments, such as down-hole in oil and gas wells. Degraded cell performance characteristics include voltage fluctuations during discharge, reduced running voltages, increased internal impedances, and reduced delivered capacities.

Prior art measures to avoid the adverse effects of titanium current collectors on cell performance resulting from storage or elevated temperature exposure have drawbacks. One such measure consists of coating an electrically conductive carbon paint suspension onto titanium cathode screens. However, variations in coating thickness and in adherence quality are but two of the factors making this a cumbersome process. Another prior art measure is to abandon titanium and employ screens made from other highly corrosion resistant alloys such as high chromium ferritic stainless steels or cobalt-nickel alloys. Many of these alloys tend to be inherently expensive and difficult to form into screens by cost-efficient processes. Furthermore, the relatively light weight of titanium is preferable and advantageous in many battery applications.

It is important to the understanding of the present invention to note that in the prior art involving the use of uncoated titanium current collectors, the titanium surface includes a very thin, invisible oxide layer that forms naturally on pure and alloyed titanium. This layer forms spontaneously in the presence of an oxygen source during mechanical and chemical forming processes including sheet/foil rolling, wire drawing, and chemical photoetch fabrication of screens. It is known to those familiar with the art that the oxide layer on titanium rapidly reaches a self-limited thickness under ambient or modestly elevated temperature conditions.

### SUMMARY OF INVENTION

Accordingly, the present invention is directed to a conditioned titanium metal substrate having a substantially thickened outer oxidation layer provided by a treatment process performed in an oxygen-containing atmosphere at elevated temperatures, or through electrolytic oxidation (anodization). Upon subsequent elevated temperature exposure, the conditioned titanium substrate serving as a cathode electrode current collector incorporated into an electrochemical cell exhibits improved electrical performance in comparison to titanium substrates manufactured by prior art techniques, i.e., electrically conductive carbon coated titanium screen and use of highly corrosion resistant alloys other than titanium. In fact, improved discharge performance is maintained even after the cell has been subjected to several high temperature exposures. The oxide thickening treatment of this invention is practical and economical; in its simplest form the treatment consists of heating screens or stock in a furnace containing an air atmosphere.

These and other aspects of the present invention will become more apparent to those skilled in the art by reference to the following description and to the appended drawings.

### BRIEF DESCRIPTION OF THE DRAWINGS

FIGS. 1 and 2 show the EDS spectra of a prior art untreated titanium screen and a thermally oxide-thickened titanium screen according to the present invention, respectively.

FIG. 3 is a graph of the discharge profiles of various heat exposed Li/CFₓ cells using as received, untreated titanium screens as the cathode current collector.

FIGS. 4 and 5 are graphs of the discharge profiles of various heat exposed Li/CFₓ cells having thermally oxidized and electrolytically oxidized titanium screens as the cathode current collector, respectively.

FIGS. 6 and 7 are electron micrograph (SEM) photos of a representative untreated titanium cathode current collector screen at 100× and 1000×, respectively.

FIGS. 8 and 9 are electron micrograph (SEM) photos of a representative thermally oxide-thickened titanium cathode current collector screen at 100× and 1000×, respectively.

FIGS. 10 and 11 are the EDS spectra of a thermally oxide-thickened titanium current collector screen and an untreated titanium screen, respectively, after destructive analysis of discharged and autoclaved Li/CFₓ cells.

### DETAILED DESCRIPTION OF THE INVENTION

The present invention provides a positive electrode current collector for alkali metal, solid cathode, liquid organic electrolyte electrochemical cells. The preferred current collector material comprises the so-called Commercially Pure (CP) or unalloyed grades of titanium. These materials are known as ASTM Grades 1 through 4, differing only slightly in chemical composition but substantially in mechanical properties. It is within the scope of the present invention that other titanium alloys available in sheet or foil form are useful for conditioning to provide them with an oxide-thickened surface layer. The titanium material may be in the form of a screen, foil, or sheet and preferably has a thickness of about 0.001 inches to about 0.010 inches.

According to the present invention, an as-received titanium substrate is conditioned with a thickened outer oxidation layer in an oxidizing atmosphere at an elevated temperature or through electrolyte oxidation. Air oxidation takes place by heating the screen in an oxidizing atmosphere at a temperature of about 200° C. to about 450° C. for a period of time ranging from about 24 hours down to about 5 minutes for the highest temperatures. A preferred oxidizing protocol comprises heating the screen at a temperature of about 300° C. for about 30 minutes in air.

Another embodiment of the present invention comprises immersing the titanium material in an electrolytic bath, such as a 10% oxalic acid solution, at an applied voltage ranging from about 3 volts to about 30 volts for a time period ranging from about 0.5 periods to about 60 seconds.

In either case, the important aspect of the present invention is the provision of a substantially thickened outer layer of titanium oxide on the exposed surface of the titanium material. When such a conditioned titanium material is used as the current collector for the cathode of a primary alkali metal electrochemical cell or the positive electrode of a lithium-ion secondary cell, such cell types are known to exhibit improved discharge performance and reduced impedance in comparison to unconditional titanium material incorporated into electrochemical electrodes.

Accordingly, the conditioned titanium current collector material of the present invention is useful in electrochemical cells of both a primary and a secondary configuration. The primary configuration can include a positive electrode of either a solid cathode active material supported on the current collector or a liquid catholyte system having a carbonaceous material supported on the conditioned titanium current collector.

Regardless of the cell configuration, such cells preferably comprise an anode active material of a metal selected from Groups IA, IIA or IIIB of the Periodic Table of the Elements, including the alkali metals lithium, sodium, potassium, etc., and their alloys and intermetallic compounds including, for example, Li—Si, Li—Al, Li—B and Li—Si—B alloys and intermetallic compounds. The preferred anode active material comprises lithium, and the more preferred anode for a primary cell comprises a lithium alloy such as a lithium-aluminum alloy. However, the greater the amount of aluminum present by weight in the alloy, the lower the energy density of the cell.

In a primary cell, the form of the anode may vary, but preferably the anode is a thin metal sheet or foil of the anode metal, pressed or rolled on a metallic anode current collector, i.e., preferably comprising nickel, to form an anode component. The anode component has an extended tab or lead of the same material as the anode current collector, i.e., preferably nickel, integrally formed therewith such as by welding and contacted by a weld to a cell case of conductive metal in a case-negative electrical configuration. Alternatively, the anode may be formed in some other geometry, such as a bobbin shape, cylinder or pellet to allow an alternate low surface cell design.

The positive electrode or cathode of the present electrochemical cell is preferably of carbonaceous materials such as graphite, carbon and fluorinated carbon. Such carbonaceous materials are useful in both liquid catholyte and solid cathode primary cells and in rechargeable, secondary cells. The positive electrode more preferably comprises a fluorinated carbon represented by the formula (CFₓ)ₙ wherein x varies between about 0.1 to 1.9 and preferably between about 0.5 and 1.2 and (C₂F)ₙ wherein the n refers to the number of monomer units which can vary widely. These electrode active materials are composed of carbon and fluorine, and include graphitic and nongraphitic forms of carbon, such as coke, charcoal or activated carbon.

Other cathode active materials useful for constructing an electrochemical cell according to the present invention are selected from a metal, a metal oxide, a metal sulfide or a mixed metal oxide. Such electrode active materials include silver vanadium oxide, copper silver vanadium oxide, manganese dioxide, titanium disulfide, copper oxide, copper sulfide, iron sulfide, iron disulfide, cobalt oxide, nickel oxide, copper vanadium oxide, and other materials typically used in alkali metal electrochemical cells. In secondary cells, the positive electrode preferably comprises a lithiated material that is stable in air and readily handled. Examples of such air-stable lithiated cathode materials include oxides, sulfides, selenides, and tellurides of such metals as vanadium, titanium, chromium, copper, molybdenum, niobium, iron, nickel, cobalt and manganese. The more preferred oxides include LiNiO₂, LiMn₂O₄, LiCoO₂, LiCo_{0.92}Sn_{0.08}O₂ and LiCo₁₋ₓNiₓO₂.

To discharge such secondary cells, the lithium metal comprising the positive electrode is intercalated into a carbonaceous negative electrode or anode by applying an externally generated electrical potential to recharge the cell. The applied recharging electrical potential serves to draw the alkali metal from the cathode material, through the electrolyte and into the carbonaceous anode to saturate the carbon comprising the anode. The cell is then provided with an electrical potential and is discharged in a normal manner.

An alternate secondary cell construction comprises intercalating the carbonaceous material with the active alkali material before the negative electrode is incorporated into the cell. In this case, the positive electrode body can be solid and comprise, but not be limited to, such materials as manganese dioxide, silver vanadium oxide, titanium disulfide, copper oxide, copper sulfide, iron sulfide, iron disulfide and fluorinated carbon. However, this approach is compromised by problems associated with handling lithiated carbon outside of the cell. Lithiated carbon tends to react when contacted by air or water.

The positive electrode for a primary or a secondary cell is prepared by mixing about 80 to about 99 weight percent of an already prepared electrode active material in a finely divided form with up to about 10 weight percent of a binder material, preferably a thermoplastic polymeric binder material. The term thermoplastic polymeric binder material is used in its broad sense and any polymeric material, preferably in a powdered form, which is inert in the cell and which passes through a thermoplastic state, whether or not it finally sets or cures, is included within the meaning “thermoplastic polymer”. Representative materials include polyethylene, polypropylene and fluoropolymers such as fluorinated ethylene and propylene, polyvinylidene fluoride (PVDF), polyethylenetetrafluoroethylene (ETFE), and polytetrafluoroethylene (PTFE), the latter material being most preferred. Natural rubbers are also useful as the binder material with the present invention.

In the case of a primary, solid cathode electrochemical cell, the cathode active material is further combined with up to about 5 weight percent of a discharge promoter diluent such as acetylene black, carbon black and/or graphite. A preferred carbonaceous diluent is KETJENBLACK® carbon. Metallic powders such as nickel, aluminum, titanium and stainless steel are also useful as conductive diluents.

Similarly, if the active material is a carbonaceous counterelectrode in a secondary cell, the electrode material preferably includes a conductive diluent and a binder material in a similar manner as the previously described primary, solid cathode electrochemical cell.

The thusly prepared cathode active admixture may be formed into a free-standing sheet prior to being contacted to the titanium current collector conditioned according to the present invention to form the positive electrode. The manner in which the cathode active admixture is prepared into a free-standing sheet is thoroughly described in U.S. Pat. No. 5,435,874 to Takeuchi et al., which is assigned to the assignee of the present and incorporated herein by reference. Further, cathode components for incorporation into a cell according to the present invention may also be prepared by rolling, spreading or pressing the cathode active admixture onto the conditioned titanium current collector of the present invention.

Cathodes prepared as described above are flexible and may be in the form of one or more plates operatively associated with at least one or more plates of anode material, or in the form of a strip wound with a corresponding strip of anode material in a structure similar to a “jellyroll”.

Whether the cell is constructed as a primary or secondary electrochemical system, the cell of the present invention includes a separator to provide physical segregation between the anode and cathode electrodes. The separator is of electrically insulative material, and the separator material also is chemically unreactive with and insoluble in the electrolyte. In addition, the separator material has a degree of porosity sufficient to allow flow therethrough of the electrolyte during the electrochemical reaction of the cell. Illustrative separator materials include fabrics woven from fluoropolymeric fibers of polyethylenetetrafluoroethylene and polyethylenechlorotrifluoroethylene used either alone or laminated with a fluoropolymeric microporous film. Other suitable separator materials include non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C. H. Dexter, Div., Dexter Corp.).

The electrochemical cell of the present invention further includes a nonaqueous, tonically conductive electrolyte which serves as a medium for migration of ions between the anode and the cathode electrodes during the electrochemical reactions of the cell. Thus, nonaqueous electrolytes suitable for the present invention are substantially inert to the anode and cathode materials, and they exhibit those physical properties necessary for ionic transport, namely, low viscosity, low surface tension and wettability.

Suitable nonaqueous electrolyte solutions that are useful in both the present primary and secondary cells having an electrode couple of alkali metal or an alkali metal-containing material, and a solid active material counterelectrode preferably comprise a combination of a lithium salt and an organic solvent system. More preferably, the electrolyte includes an ionizable alkali metal salt dissolved in an aprotic organic solvent or a mixture of solvents comprising a low viscosity solvent and a high permittivity solvent. The inorganic, ionically conductive salt serves as the vehicle for migration of the alkali metal ions to intercalate into the counterelectrode. Preferably, the ion-forming alkali metal salt is similar to the alkali metal comprising the anode active material. Suitable salts include LiPF₆, LiBF₄, LiAsF₆, LiSbF₆, LiClO₄, LiAlCl₄, LiGaCl₄, LiC(SO₂CF₃)₃, LiO₂, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, and mixtures thereof. Suitable salt concentrations typically range between about 0.8 to 1.5 molar.

In electrochemical systems having a solid cathode or in secondary cells, the nonaqueous solvent system comprises low viscosity solvents including tetrahydrofuran (THF), methyl acetate (MA), diglyme, trigylme, tetragylme, dimethyl carbonate (DMC), ethylmethyl carbonate (EMC), 1,2-dimethoxyethane (DME), diisopropylether, 1,2-diethoxyethane, 1-ethoxy,2-methoxyethane, dipropyl carbonate, ethylmethyl carbonate, methylpropyl carbonate, ethylpropyl carbonate, diethyl carbonate, and mixtures thereof. While not necessary, the electrolyte also preferably includes a high permittivity solvent selected from cyclic carbonates, cylic esters and cyclic amides such as propylene carbonate (PC), ethylene carbonate (EC), butylene carbonate, acetonitrile, dimethyl sulfoxide, dimethyl formamide, dimethyl acetamide, γ-butyrolactone (GBL), γ-valerolactone, N-methyl-pyrrolidinone (NMP), and mixtures thereof. For a solid cathode primary or secondary cell having lithium as the anode active material, such as of the Li/SVO couple, the preferred electrolyte is LiAsF₆ in a 50:50, by volume, mixture of PC/DME. For a Li/CFₓ cell, the preferred electrolyte is 1.0M to 1.4M LiBF₄ in γ-butyrolactone (GBL).

The preferred form of a primary alkali metal/solid cathode electrochemical cell is a case-negative design wherein the anode is in contact with a conductive metal casing and the cathode contacted to the conditioned titanium current collector is the positive terminal. In a secondary electrochemical cell having a case-negative configuration, the anode (counterelectrode)/cathode couple is inserted into the conductive metal casing such that the casing is connected to the carbonaceous counterelectrode current collector, and the lithiated material is contacted to a second current collector, which also preferably is of conditioned titanium according to the present invention. In either case, the current collector for the lithiated material or the cathode electrode is in contact with the positive terminal pin via a lead of the same material as the current collector which is welded to both the current collector and the positive terminal pin for electrical contact.

A preferred material for the casing is titanium although stainless steel, mild steel, nickel-plated mild steel and aluminum are also suitable. The titanium casing can be conditioned in a manner according to the present invention. The casing header comprises a metallic lid having an opening to accommodate the glass-to-metal seal/terminal pin feedthrough for the cathode electrode. The anode electrode or counterelectrode is preferably connected to the case or the lid. An additional opening is provided for electrolyte filling. The casing header comprises elements having compatibility with the other components of the electrochemical cell and is resistant to corrosion. The cell is thereafter filled with the electrolyte solution described hereinabove and hermetically sealed such as by close-welding a titanium plug over the fill hole, but not limited thereto. The cell of the present invention can also be constructed in a case-positive design.

The electrochemical cell of the present invention comprising the conditioned titanium substrate as the positive electrode current collector operates in the following manner. When the ionically conductive electrolytic solution becomes operatively associated with the anode and the cathode of the cell, an electrical potential difference is developed between terminals operatively connected to the anode and the cathode. The electrochemical reaction at the anode includes oxidation to form metal ions during cell discharge. The electrochemical reaction at the cathode involves intercalation or insertion of ions which migrate from the anode to the cathode and conversion of those ions into atomic or molecular forms.

The following examples describe the manner and process of manufacturing and discharging an electrochemical cell according to the present invention, and they set forth the best mode contemplated by the inventors of carrying out the invention, but they are not to be construed as limiting.

### EXAMPLE I

Six substantially similar titanium screens were divided into two groups of three screens each. The first group, serving as a control, was not conditioned. It was inferred from the colorless gray metallic appearance of these screens that the surface oxide present was the typical thin invisible layer known to form during mechanical and chemical processing at temperatures near ambient. The second group of three screens was conditioned by heating in air at about 300° C. for about 30 minutes. The presence of an augmented (thickened) oxide on the conditioned screens was confirmed by a visible color change to a light to moderate straw color. It is known to those who have studied the growth of oxides on metals that the initial colors developing as oxide thickening progresses are due to optical interference colors. That is, when a certain oxide thickness range is reached, wavelengths of light visible to the human eye are reinforced such that a color is perceived. A straw color is typically the first one seen on many oxidized metals.

Further confirmation of oxide thickness growth due to the oxidation treatments of this invention was confirmed by noting changes in the x-ray (EDS) spectra of screens examined in a scanning electron microscope (SEM). While the EDS analyses were not quantitative, very clear semi-quantitative data was obtained by careful side-by-side comparison of the control and oxidized samples using low (5 kV) electron beam voltage in the SEM to enhance EDS sensitivity to surface layer composition.

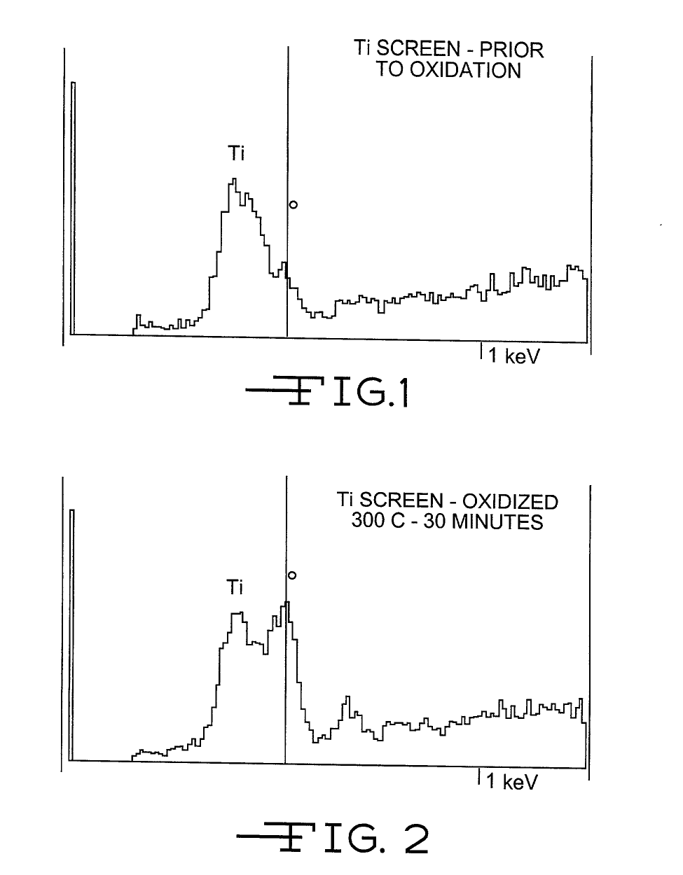

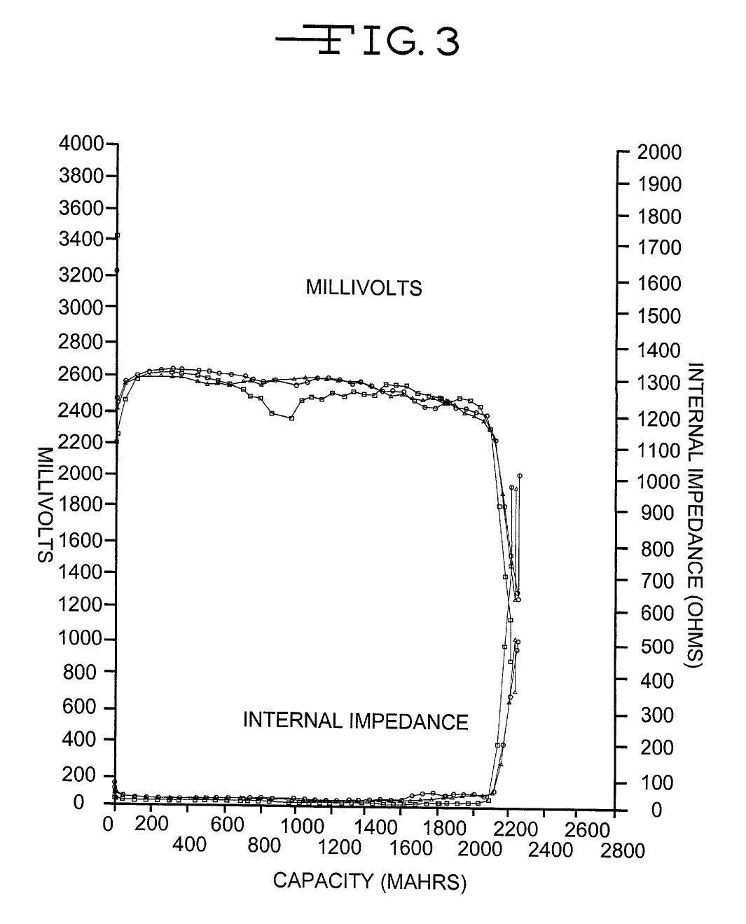

Oxide thickening is shown by comparing the EDS spectra of FIGS. 1 and 2. In particular, FIG. 1 shows an EDS spectra from a representative control group screen exhibiting an oxygen peak (at about 0.53 KeV) of a much lesser intensity than the nearby titanium peak. This peak height relationship indicates that the electron beam (which produces the x-rays that result in EDS spectra) is readily penetrating the very thin surface oxide layer. Consequently, the x-ray return is proportionately more intense from the underlying titanium metal substrate than from the surface oxide.

In FIG. 2, representing a typical conditioned (oxidized) screen sample, the oxygen peak is comparatively increased in intensity relative to the titanium peak. This signifies a substantially thickened oxide such that a lesser portion of the 5 kV electron beam penetrates through the surface oxide to the substrate. Consequently, there is a relatively greater x-ray return from the oxide layer for this treated screen. Discharge results of Li/CFₓ cells containing the untreated titanium screens are set forth in Table 1 and in Table 2 for the thermally oxidized screens.

### EXAMPLE II

Thirty-six substantially similar titanium screens were divided into twelve groups of three screens each. Each group was subjected to electrolytic oxidation or anodization at various applied voltages for various periods of time. In particular, electrolytic oxidation (anodization) was performed by suspending the titanium screens in an electrolytic bath. A piece of copper proportional to the screen being anodized served as the counter electrode. As current from a DC power supply passed through the bath, oxygen created at the titanium anode screen surface reacted with the metal, forming titanium oxide, the thickness of which varied as a function of current application. The electrolytic bath used to treat the titanium screens was a 10% oxalic acid solution. However, according to the present invention, almost any liquid capable of carrying current is useful for this purpose. Suitable liquids range from COCA COLA® to sulfuric acid. As set forth in Tables 3 to 14 below under the heading “screen type”, the applied voltages ranged from 3 to 30 volts, with the time of application ranging from 0.5 to 60 seconds. Tables 3 to 14 list the discharge results of Li/CFₓ cells containing the variously anodized screens.

### EXAMPLE III

Prismatic, 8.6 mm Li/CFₓ cells of a central cathode design were used as the test vehicles. The cells were constructed to deliver a theoretical capacity of 2.465 Ah, with a 16% lithium excess, based on theoretical capacity. The various non-oxidized, thermally oxidized and electrolytically oxidized titanium screens listed in Tables 1 to 14 served as the cathodic current collectors. The anodes consisted of lithium (0.74±0.01 g) pressed to nickel screens.

The cathode active material consisted of flourinated carbon mixed with 5%, by weight, PTFE. A charge of 3.15 g of this active admixture was pressed to a conditioned titanium screen, i.e., conditioned either by thermal oxidation or electrolytic oxidation according to the present invention, and then heat-sealed into a non-woven polypropylene separator bag. One molar LiBF₄ in γ-butyrolactone served as the electrolyte (3.80±0.15 g).

The cells containing the non-oxidized, thermally oxidized and electrolytically oxidized titanium screens were preconditioned at 37° C. by discharge under 1.5 kohm loads for 18 hours. After a one week open circuit storage period at 37° C., a 20 mA acceptance pulse train comprised of four pulses, each of a ten second duration immediately followed by a fifteen second rest period, was applied at 37° C. to each cell. After a ten day open circuit storage period at 37° C., the cells were subjected to elevated temperature storage consisting of five, sixty minute heat cycles at 130° C. for autoclave simulation. Discharge at 37° C. under 1 kohm loads was begun within 5 days after autoclave simulation. Closed circuit voltage and 1 kHz impedance readings were recorded daily throughout run-down. AC impedance spectra were also recorded prior to and following cell autoclave simulation.

Results:

Tables 1 to 14 list the discharge results of the various cell groups having the non-oxidized titanium screens (Table 1), the thermally oxidized titanium screens (Table 2) and the electrolytically oxidized titanium screens (Tables 3 to 14) prior to autoclave simulation.

TABLE 1

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 90388 | untreated | 2729 | 4 | 2638 | 2355 |
| 90389 | | 2739 | 10 | 2605 | 2363 |
| 90390 | | 2734 | 10 | 2650 | 2363 |
| mean | | 2734 | 8 | 2631 | 2360 |
| ±1 SD | | 5 | 3 | 23 | 5 |

TABLE 2

| | | last | last | | |
|---|---|---|---|---|---|
| cell | | loaded | loaded | pulse 1 | pulse |
| serial | screen | voltage, | impedance | minimum | minimum |
| number | type | (mV) | (Ω) | (mV) | (mV) |
| 90394 | 300° C. | 2698 | 8 | 2250 | 2165 |
| | for | | | | |
| 90395 | 30 | 2648 | 9 | 2100 | 2050 |
| | min. | | | | |
| | in air | | | | |
| 90396 | | 2692 | 8 | 2230 | 2138 |
| mean | | 2679 | 8 | 2193 | 2118 |
| ±1 SD | | 27 | 1 | 81 | 60 |

TABLE 3

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100302 | 5 V for | 2673 | 11 | 2095 | 2012 |
| | 5 sec | | | | |
| 100303 | | 2666 | 11 | 2024 | 1960 |
| 100304 | | 2669 | 11 | 2034 | 1948 |
| mean | | 2669 | 11 | 2051 | 1973 |
| ±1 SD | | 4 | 0 | 38 | 34 |

TABLE 4

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100305 | 10 V | 2637 | 10 | 1938 | 1895 |
| | for 5 | | | | |
| | sec | | | | |
| 100306 | | 2650 | 13 | 1929 | 1848 |
| 100307 | | 2633 | 15 | 1765 | 1675 |
| mean | | 2640 | 13 | 1877 | 1806 |
| ±1 SD | | 9 | 3 | 97 | 116 |

TABLE 5

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100308 | 10 V | 2654 | 11 | 2065 | 2000 |
| | for 15 | | | | |
| | sec | | | | |
| 100309 | | 2653 | 11 | 2139 | 2078 |
| 100310 | | 2640 | 12 | 2031 | 1980 |
| mean | | 2649 | 11 | 2078 | 2019 |
| ±1 SD | | 8 | 1 | 55 | 52 |

TABLE 6

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100311 | 10 V | 2640 | 11 | 2046 | 1992 |
| | for 30 | | | | |
| | sec | | | | |
| 100312 | | 2651 | 10 | 2029 | 1975 |
| 100313 | | 2667 | 11 | 2151 | 2087 |
| mean | | 2653 | 11 | 2075 | 2018 |
| ±1 SD | | 14 | 1 | 66 | 60 |

TABLE 7

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100314 | 10 V | 2638 | 10 | 1851 | 1846 |
| | for 60 | | | | |
| | sec | | | | |
| 100315 | | 2657 | 10 | 1907 | 1853 |
| 100316 | | 2646 | 10 | 1926 | 1877 |
| mean | | 2647 | 10 | 1895 | 1859 |
| ±1 SD | | 10 | 0 | 39 | 16 |

TABLE 8

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100317 | 15 V | 2637 | 10 | 1816 | 1799 |
| | for 5 | | | | |
| | sec | | | | |
| 100318 | | 2650 | 10 | 1892 | 1851 |
| 100319 | | 2649 | 10 | 1921 | 1882 |
| mean | | 2645 | 10 | 1876 | 1844 |
| ±1 SD | | 7 | 0 | 54 | 42 |

TABLE 9

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100320 | 20 V | 2637 | 13 | 1785 | 1777 |
| | for 5 | | | | |
| | sec | | | | |
| 100321 | | 2648 | 11 | 1912 | 1848 |
| 100322 | | 2654 | 11 | 1992 | 1914 |
| mean | | 2646 | 12 | 1896 | 1846 |
| ±1 SD | | 9 | 1 | 104 | 69 |

TABLE 10

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100323 | 25 V | 2660 | 15 | 1953 | 1897 |
| | for 5 | | | | |
| | sec | | | | |
| 100324 | | 2634 | 12 | 1841 | 1829 |
| 100325 | | 2643 | 13 | 1736 | 1785 |
| mean | | 2646 | 13 | 1843 | 1837 |
| ±1 SD | | 13 | 2 | 109 | 56 |

TABLE 11

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 100326 | 30 V | 2658 | 11 | 1980 | 1924 |
| | for 5 | | | | |
| | sec | | | | |
| 100327 | | 2642 | 12 | 1965 | 1916 |
| 100328 | | 2642 | 12 | 1924 | 1877 |
| mean | | 2647 | 12 | 1956 | 1905 |
| ±1 SD | | 9 | 1 | 29 | 24 |

TABLE 12

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 102333 | 3 V for | 2726 | 11 | 2566 | 2366 |
| | 1 sec | | | | |
| 102334 | | 2733 | 9 | 2673 | 2334 |
| 102335 | | 2724 | 11 | 2544 | 2236 |
| mean | | 2728 | 10 | 2594 | 2279 |
| ±1 SD | | 5 | 1 | 69 | 50 |

TABLE 13

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 102336 | 5 V for | 2690 | 10 | 2717 | 2485 |
| | 1 sec | | | | |
| 102337 | | 2706 | 10 | 2454 | 2346 |
| 102338 | | 2700 | 10 | 2212 | 2007 |
| mean | | 2699 | 10 | 2461 | 2279 |
| ±1 SD | | 8 | 0 | 253 | 246 |

TABLE 14

| | | last | last | | |
|---|---|---|---|---|---|
| cell | | loaded | loaded | pulse 1 | pulse 4 |
| serial | screen | voltage | impedance | minimum | minimum |
| number | type | (mV) | (Ω) | (mV) | (mV) |
| 102339 | 5 V for | 2700 | 11 | 2217 | 2036 |
| | 0.5 | | | | |
| | sec | | | | |
| 102340 | | 2713 | 10 | 2400 | 2117 |
| 102341 | | 2691 | 11 | 2048 | 1946 |
| mean | | 2701 | 11 | 2222 | 2033 |
| ±1 SD | | 11 | 1 | 176 | 855 |

As set forth in the tables, the cells having thermally and electrolytically oxidized titanium screens had lower pulse 1 voltage minima under a 20 mA pulse than cells fabricated with untreated titanium current collectors. However, the voltages of cells with thermally oxidized screens and some of them with electrolytically oxidized screens did not fall below 2V.

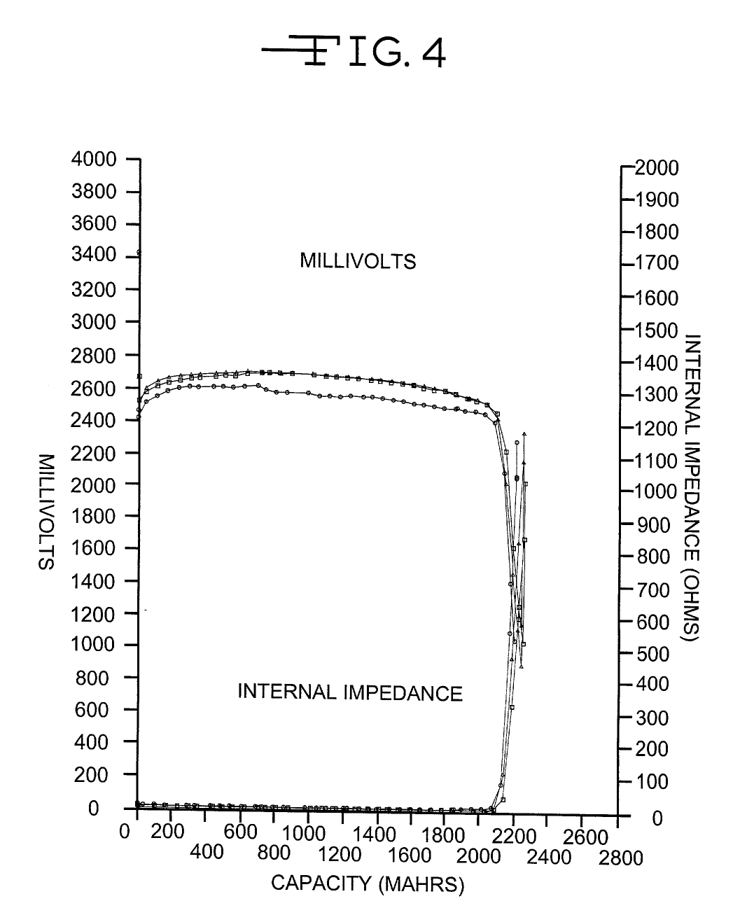

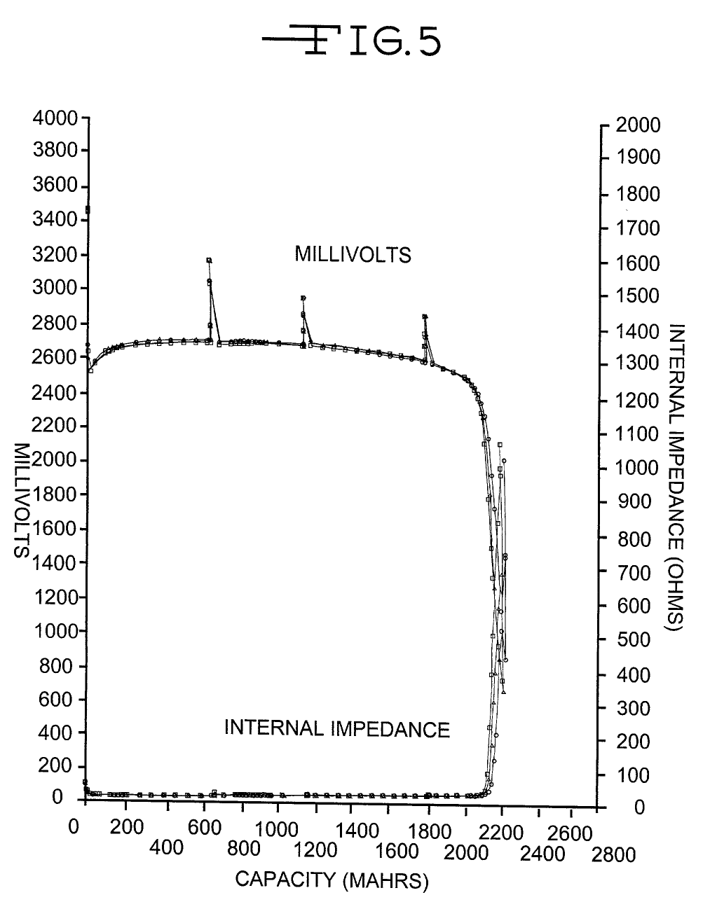

As can be seen in FIG. 3, the discharge profiles of Li/CFₓ cells subjected to elevated temperature storage and using as-received, untreated titanium screens were erratic. This condition is eliminated through the use of oxidized titanium current collectors. The discharge results of the cells set forth in Tables 2 and 13 are illustrated in FIGS. 4 and 5, respectively. The cells of Table 2 containing screens thermally oxidized at 300° C. for 30 minutes in air exhibited smooth discharge profiles with higher running voltages than the electrolytically oxidized cells of Table 13 (anodized at 5V for 1 sec). Another difference between the cell groups is the internal impedance recorded during discharge. For the cells using as-received titanium screens (FIG. 3), the internal impedance is higher throughout cell life than the impedance of cells having conditioned titanium screens. This is shown by the cell groups used to construct FIGS. 4 and 5 oxidized by either treatment. According to the present invention, a cell exhibiting reduced impedance is advantageous for applications in which clarity of transmission signal is required.

### EXAMPLE IV

As listed in Table 16, the mean discharge capacity of Li/CFₓ cells subjected to elevated temperature storage and using oxidized titanium screens was 2,147±12 mAh to a 2V cut-off. In comparison, the mean capacity of Li/CFₓ cells subjected to elevated temperature storage and using untreated titanium screens was 2,153±16 mAh to 2V, as listed in Table 15. The results in Table 15 are from the cells in Table 1 and the results in Table 16 are from the cells set forth in Table 2. When normalized with respect to cathode weight, the mean gravimetric energy densities were 681.75±5.32 mAh/g for the cells subjected to autoclave simulation with untreated cathode screens (Tables 1 and 15) and 679.61±4.00 mAh/g for those cells using oxidized titanium current collectors (Tables 2 and 16). Although the mean delivered capacity is lower for the cells subjected to elevated temperature storage using the oxidized screens, the difference is not statistically significant.

Also listed in Tables 15 and 16 are the running voltages and watt-hours delivered to 2V. The Li/CFₓ cells subjected to elevated temperature storage utilizing oxidized titanium screen cathodic current collectors according to the present invention had higher running voltages, and thus higher energies, than the Li/CFₓ cells with as-received titanium screens according to the prior art.

TABLE 15

| cell | | | | |
|---|---|---|---|---|
| serial | screen | running | capacity | energy to |
| number | type | voltage, V | to 2V, Ah | 2V, Wh |
| 90388 | untreated | 2.56 | 2.135 | 5.47 |
| 90389 | | 2.60 | 2.163 | 5.62 |
| 90390 | | 2.60 | 2.162 | 5.62 |
| mean | | 2.59 | 2.153 | 5.57 |
| ±1 SD | | 0.02 | 0.016 | 0.09 |

TABLE 16

| cell | | | | |
|---|---|---|---|---|
| serial | screen | running | capacity | energy to |
| number | type | voltage, V | to 2V, Ah | 2V, Wh |
| 90394 | 300° C. | 2.70 | 2.159 | 5.83 |
| | for | | | |
| 90395 | 30 | 2.60 | 2.135 | 5.55 |
| | minutes | | | |
| 90396 | in air | 2.70 | 2.146 | 5.79 |
| mean | | 2.67 | 2.147 | 5.72 |
| ±1 SD | | 0.06 | 0.012 | 0.15 |

Table 17 presents the closed circuit voltages, impedances, and delivered capacities of the cells subjected to elevated temperature storage and using screens anodized by various voltage/time condition combinations. In particular, the results from the Li/CFₓ cells presented in Tables 12 to 14 are set forth in Table 17 along with newly presented cell serial numbers 102342 to 102344 having untreated titanium cathode current collector screens. In addition, the voltage minima recorded for pulse 1 and pulse 4 wave trains under a 20 mA four-wave pulse train applied at 0%, 30%, 60%, and 90% depths-of-discharge are listed. The pulse train is similar to that described in Example II.

According to the present invention, anodization treatment of a titanium screen provides a titanium oxide layer which protects the titanium metal surface from reactions forming species capable of reducing electron transporting capability. Anodization treatments at a potential of 5V applied for either 0.5 or 1 second, as described herein, did not result in a measurable increase in the electrical resistance of the screen/cathode interface.

TABLE 17

| | | | | | | 30% DOD | 30% DOD | 60% DOD | 60% DOD | 90% DOD | 90% DOD |
|---|---|---|---|---|---|---|---|---|---|---|---|
| | | | | | | pulse 1 | pulse 4 | pulse 1 | pulse 4 | pulse 1 | pulse 4 |
| | | running | internal | capacity | energy | min | min | min | min | min | min |
| serial | screen | voltage, | impedance, | to 2 V, | to 2 V, | voltage, | voltage, | voltage | voltage | voltage, | voltage |
| number | type | V | Ω | Ah | Wh | mV | mV | mV | mV | mV | mV |
| 102333 | 3 V for 1 | 2.70 | 10 | 2.122 | 5.73 | 2290 | 2261 | 2334 | 2307 | 2207 | 2178 |
| | sec | | | | | | | | | | |
| 102334 | | 2.65 | 13 | 2.195 | 5.82 | 2004 | 1995 | 2002 | 1987 | 1919 | 1897 |
| 102335 | | 2.67 | 11 | 2.183 | 5.83 | 2102 | 2080 | 2195 | 2170 | 1931 | 1907 |
| mean | | 2.67 | 11 | 2.167 | 5.79 | 2132 | 2112 | 2177 | 2155 | 2019 | 1994 |
| ±1 SD | | 0.03 | 2 | 0.039 | 0.06 | 145 | 136 | 167 | 161 | 163 | 159 |
| 102336 | 5 V for 1 | 2.69 | 5 | 2.176 | 5.85 | 2244 | 2222 | 2537 | 2524 | 2131 | 2109 |
| | sec | | | | | | | | | | |
| 102337 | | 2.69 | 5 | 2.201 | 5.92 | 2271 | 2246 | 2527 | 2517 | 2078 | 2058 |
| 102338 | | 2.70 | 5 | 2.185 | 5.90 | 2319 | 2292 | 2344 | 2319 | 2153 | 2129 |
| mean | | 2.69 | 5 | 2.187 | 5.89 | 2278 | 2253 | 2469 | 2453 | 2121 | 2099 |
| ±1 SD | | 0.01 | 0 | 0.013 | 0.04 | 38 | 36 | 109 | 116 | 39 | 37 |
| 102339 | 5 V for | 2.69 | 5 | 2.197 | 5.91 | 2263 | 2239 | 2271 | 2253 | 2266 | 2244 |
| | 0.5 sec | | | | | | | | | | |
| 102340 | | 2.69 | 5 | 2.218 | 5.97 | 2236 | 2209 | 2239 | 2217 | 2095 | 2073 |
| 102341 | | 2.70 | 5 | 2.164 | 5.84 | 2317 | 2285 | 2280 | 2253 | 2097 | 2073 |
| mean | | 2.69 | 5 | 2.193 | 5.91 | 2272 | 2244 | 2263 | 2241 | 2153 | 2130 |
| ±1 SD | | 0.01 | 0 | 0.027 | 0.07 | 41 | 38 | 22 | 21 | 98 | 99 |
| 102342 | untreated | 2.70 | 13 | 2.174 | 5.87 | 2209 | 2183 | 2173 | 2148 | 2017 | 1990 |
| 102343 | | 2.69 | 13 | 2.214 | 5.96 | 2212 | 2183 | 2207 | 2183 | 1985 | 1965 |
| 102334 | | 2.69 | 13 | 2.188 | 5.89 | 2129 | 2102 | 2034 | 2019 | 1646 | 1643 |
| mean | | 2.69 | 13 | 2.192 | 5.91 | 2183 | 2156 | 2138 | 2117 | 1883 | 1866 |
| ±1 SD | | 0.01 | 0 | 20 | 0.05 | 47 | 47 | 92 | 86 | 206 | 19 |

### EXAMPLE V

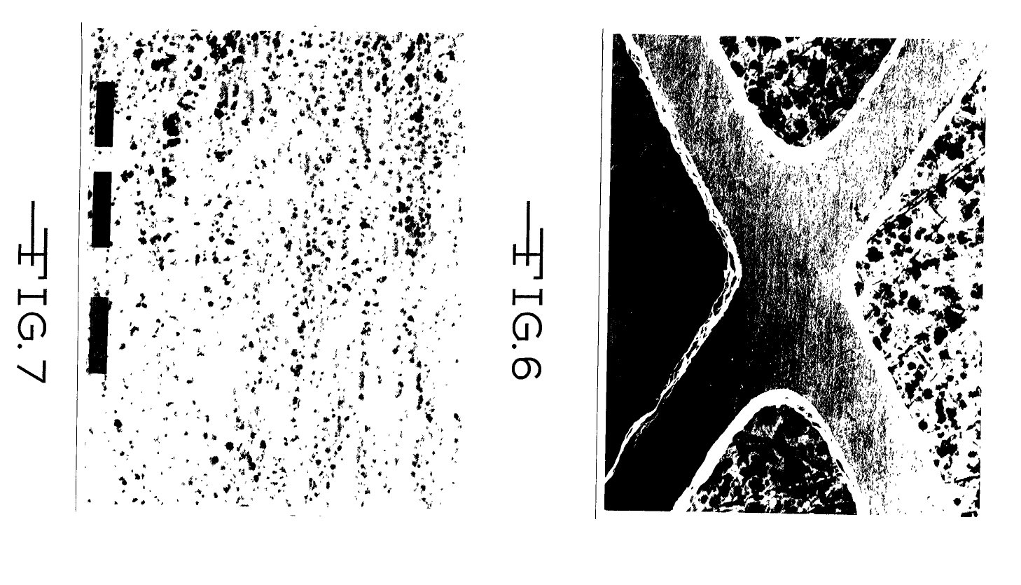

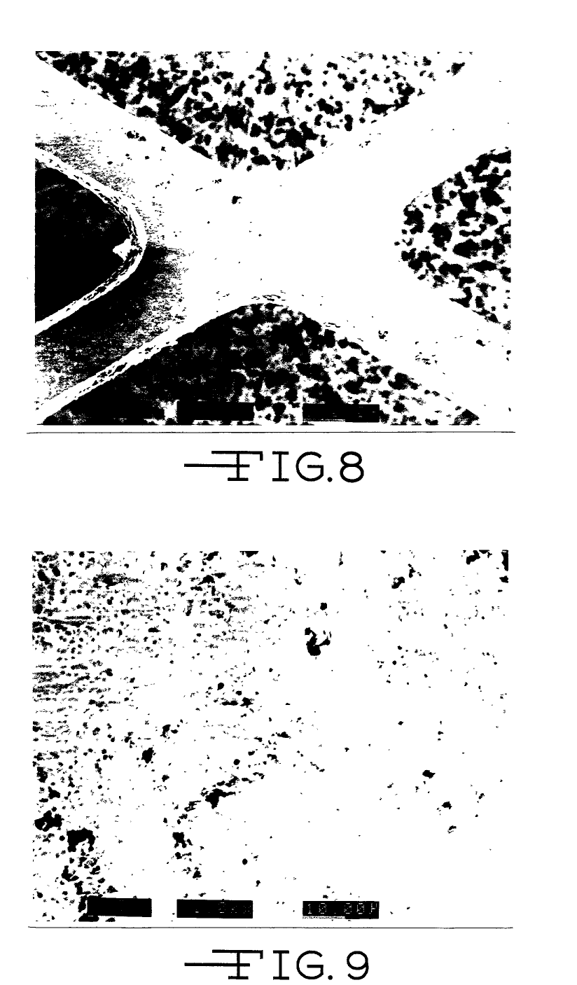

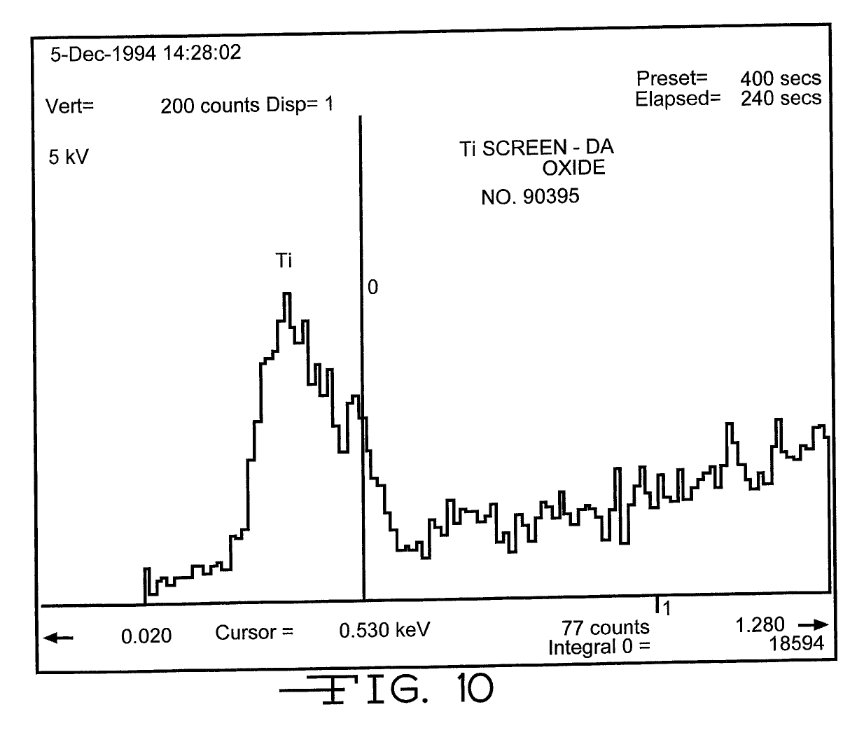

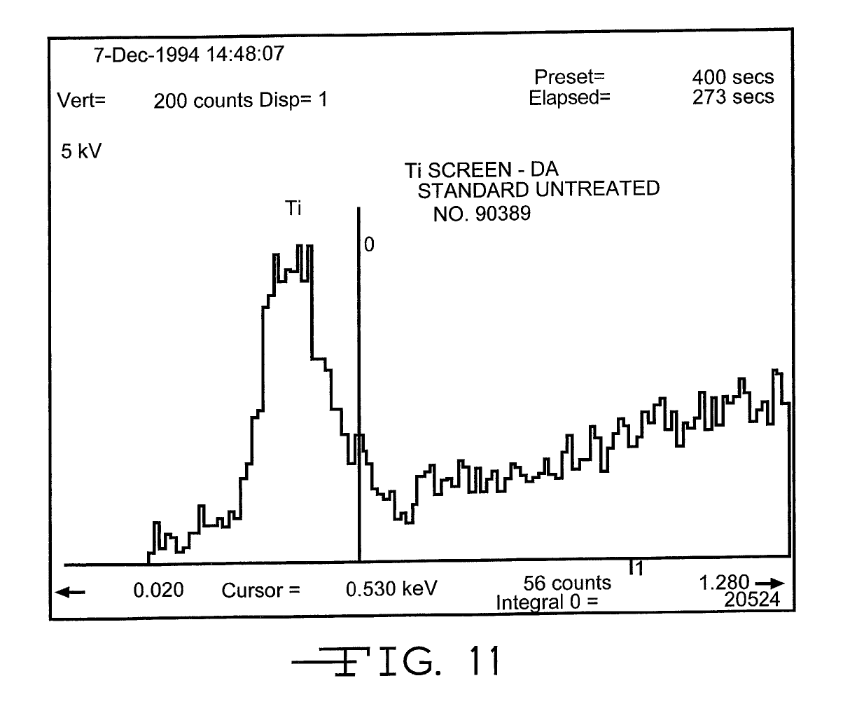

Following discharge, the Li/CFₓ cells were disassembled and the cathode screens investigated for possible corrosion. As shown in FIGS. 6 to 9, the scanning electron micrograph (SEM) photos reveal that there is no appreciable enhancement of undesirable screen pitting due to thermal oxidation when compared with standard, untreated screens. EDS spectra representing the outer surfaces of screens taken from the disassembled (DA) cells are shown in FIGS. 10 and 11. The fact that the thickened oxide layer resulting from thermal oxidation remains at least partially intact after discharge can be seen by noting the relative peak heights for oxygen and titanium. The EDS spectra in FIG. 10 is typical of the thermally oxidized screens of the present invention. The oxygen peak height is greater than half that of the Ti peak. FIG. 11 is an EDS spectra representing as-received (untreated) screens after discharge. As shown, the oxygen peak stands much lower, which is typical for titanium screens not thermally or electrolytically oxidized.

It is appreciated that various modifications to the inventive concepts described herein may be apparent to those of ordinary skill in the art without departing from the spirit and scope of the present invention as defined by the appended claims.

What is claimed:

1. An electrochemical cell, which comprises:
a) a casing;
b) an anode disposed inside the casing;
c) a cathode in electrical association with the anode inside the casing, wherein the cathode comprises a cathode active material contacted to a titanium current collector provided with thickened titanium oxide on an outer surface thereof and in contact with the cathode active material; and
d) an electrolyte.

2. The electrochemical cell of claim 1 wherein the titanium current collector is either a screen or a foil.

3. The electrochemical cell a claim 1 wherein the titanium oxide is characterized as having been provided by subjecting the titanium current collector to oxidation at an elevated temperature in an oxygen-containing environment.

4. The electrochemical cell of claim 3 wherein the oxidizing atmosphere is air.

5. The electrochemical cell of claim 3 wherein the elevated temperature is at least about 200° C. for at least about 5 minutes.

6. The electrochemical cell of claim 1 wherein the thickened titanium oxide is characterized as having been provided by subjecting the titanium current collector to an electrolytic bath at an applied voltage of about 3 volts to about 30 volts.

7. The electrochemical cell of claim 6 wherein the titanium current collector is subjected to the applied voltage for a time period ranging from about 0.5 second to about 60 seconds.

8. The electrochemical cell of claim 1 wherein the thickened titanium oxide is characterized as having been provided by subjecting the titanium current collector to an electrolytic bath of oxalic acid at an applied voltage of about 3 volts to about 30 volts for a time period ranging from about 0.5 seconds to about 60 seconds.

9. The electrochemical cell of claim 1 wherein the cathode active material is selected from the group consisting of silver vanadium oxide, copper silver vanadium oxide, copper vanadium oxide, manganese dioxide, cobalt oxide, nickel oxide, copper oxide, titanium disulfide, copper sulfide, iron sulfide, iron disulfide, carbon, fluorinated carbon, and mixtures thereof.

10. The electrochemical cell of claim 1 wherein the cathode active material is selected from the group consisting of a carbonaceous material, a metal, a metal oxide, a mixed metal oxide, a metal sulfide, and mixtures thereof.

11. The electrochemical cell of claim 1 wherein the cathode further comprises a binder material and a conductive additive.

12. The electrochemical cell of claim 11 wherein the binder material is selected from the group consisting of polytetrafluoroethylene, polyvinylidene fluoride, polyethylenetetrafluoroethylene, polyamides, polyimides, and mixtures thereof.

13. The electrochemical cell of claim 11 wherein the conductive additive is selected from the group consisting of carbon, graphite powder, acetylene black, titanium powder, aluminum powder, nickel powder, stainless steel powder, and mixtures thereof.

14. The electrochemical cell of claim 1 wherein the cathode comprises from about 0 to 3 weight percent carbon, about 1 to 5 weight percent of a powder fluoro-resin and about 94 weight percent of the cathode active material.

15. An electrode, which comprises:
a) an electrode active material; and
b) a titanium current collector provided with thickened titanium oxide on an outer surface thereof and in contact with the electrode active material.

16. The electrode of claim 15 wherein the titanium current collector is either a screen or a foil.

17. The electrode of claim 15 wherein the thickened titanium oxide is characterized as having been provided by subjecting the titanium current collector to oxidation at an elevated temperature in an oxygen-containing environment.

18. The electrode of claim 17 wherein the oxidizing atmosphere is air.

19. The electrode cell of claim 17 wherein the elevated temperature is at least about 200° C. for at least about 5 minutes.

20. The electrochemical cell of claim 15 wherein the thickened titanium oxide is characterized as having been provided by subjecting the titanium current collector to an electrolytic bath at an applied voltage of about 3 volts to about 30 volts.

21. The electrode of claim 20 wherein the titanium current collector is subjected to the applied voltage for a time period ranging from about 0.5 second to about 60 seconds.

22. The electrode of claim 15 wherein the thickened titanium oxide is characterized as having been provided by subjecting the titanium current collector to an electrolytic bath of oxalic acid at an applied voltage of about 3 volts to about 30 volts for a time period ranging from about 0.5 seconds to about 60 seconds.

23. The electrode of claim 15 wherein the electrode active material is selected from the group consisting of silver vanadium oxide, copper silver vanadium oxide, copper vanadium oxide, manganese dioxide, cobalt oxide, nickel oxide, copper oxide, titanium disulfide, copper sulfide, iron sulfide, iron disulfide, carbon, fluorinated carbon, and mixtures thereof.

24. The electrode of claim 15 wherein the cathode active material is selected from the group consisting of a carbonaceous material, a metal, a metal oxide, a mixed metal oxide, a metal sulfide, and mixtures thereof.

25. The electrode of claim 15 wherein the electrode further comprises a binder material and a conductive additive.

26. The electrode of claim 25 wherein the binder material is selected from the group consisting of polytetrafluoroethylene, polyvinylidene fluoride, polyethylenetetrafluoroethylene, polyamides, polyimides, and mixtures thereof.

27. The electrode of claim 25 wherein the conductive additive is selected from the group consisting of carbon, graphite powder, acetylene black, titanium powder, aluminum powder, nickel powder, stainless steel powder, and mixtures thereof.

28. The electrode of claim 1 wherein the electrode comprises from about 0 to 3 weight percent carbon, about 1 to 5 weight percent of a powder fluoro-resin and about 94 weight percent of the electrode active material.

29. A method for constructing an electrochemical cell comprising the steps of:
a) providing an anode;
b) providing a cathode active material contacted to a titanium current collector provided with a thickened titanium oxide on an outer surface thereof and in contact with the cathode active material to provide the cathode; and
c) activating the anode and cathode with an electrolyte.

30. The method of claim 29 wherein the titanium current collector is either a screen or a foil.

31. The method of claim 29 including subjecting the titanium current collector to oxidation at an elevated temperature in an oxygen-containing environment.

32. The method of claim 29 wherein the oxidizing atmosphere is air.

33. The method of claim 29 wherein the elevated temperature is at least about 200° C. for at least about 5 minutes.

34. The method of claim 29 including subjecting the titanium current collector to an electrolytic bath at an applied voltage of about 3 volts to about 30 volts.

35. The method of claim 29 wherein the titanium current collector is subjected to the applied voltage for a time period ranging from about 0.5 second to about 60 seconds.

36. The method of claim 29 wherein the thickened titanium oxide is characterized as having been provided by subjecting the titanium current collector to an electrolytic bath of oxalic acid at an applied voltage of about 3 volts to about 30 volts for a time period ranging from about 0.5 seconds to about 60 seconds.

37. The method of claim 29 including selecting the cathode active material from the group consisting of silver vanadium oxide, copper silver vanadium oxide, copper vanadium oxide, manganese dioxide, cobalt oxide, nickel oxide, copper oxide, titanium disulfide, copper sulfide, iron sulfide, iron disulfide, carbon, fluorinated carbon, and mixtures thereof.

38. The method of claim 29 including mixing the cathode active material with a binder material prior to contact with the current collector, wherein the binder is selected from the group consisting of polytetrafluoroethylene, polyvinylidene fluoride, polyethylenetetrafluoroethylene, polyamides, polyimides, and mixtures thereof.

39. The method of claim 29 including mixing the cathode active material with a conductive additive prior to contact with the current collector, wherein the conductive additive is selected from the group consisting of carbon, graphite powder, acetylene black, titanium powder, aluminum powder, nickel powder, stainless steel powder, and mixtures thereof.
